(19) United States
(12) Patent Application Publication
(10) Pub. No.: US 2021/0073632 A1
(43) Pub. Date: Mar. 11, 2021

(54) METHODS, SYSTEMS, ARTICLES OF MANUFACTURE, AND APPARATUS TO GENERATE CODE SEMANTICS

(71) Applicant: Intel Corporation, Santa Clara, CA (US)

(72) Inventors: Roshni G. Iyer, Fremont, CA (US); Justin Gottschlich, Santa Clara, CA (US); Joseph Tarango, Longmont, CO (US); Jim Baca, Corrales, NM (US); Niranjan Hasabnis, Sunnyvale, CA (US)

(21) Appl. No.: 16/951,799

(22) Filed: Nov. 18, 2020

(51) Int. Cl. G06N 3/08; G06N 3/04

(52) U.S. Cl. CPC G06N 3/08; G06K 9/6224; G06N 3/04

(57) ABSTRACT

Methods, apparatus, systems and articles of manufacture are disclosed for generating code semantics. An example apparatus includes a concept controller to assign semantic labels to repository data to generate a training set, the semantic labels stored in a first semantic graph, the training set including a first code block associated with a first semantic label and a second code block associated with a second semantic label, a concept determiner to generate a first block embedding based on the first code block and a second block embedding based on the second code block, a graph generator to link the first block embedding to the second block embedding to form a second semantic graph, and a graph parser to output at least one of the first code block or the second code block corresponding to a query based on the second semantic graph.

### FIELD OF THE DISCLOSURE

This disclosure relates generally to code semantics, and, more particularly, to methods, systems, articles of manufacture, and apparatus to generate code semantics.

### BACKGROUND

In recent years, the use of code repositories (e.g., archives, etc.) has increased. Code repositories can be public or private databases and store source code of software, documentation, web pages, etc. For example, users can submit and look up sections of code for bug tracking, documentation, release management, version control, etc.

### BRIEF DESCRIPTION OF THE DRAWINGS

FIG. 1 illustrates an example code analysis system constructed in accordance with the teachings of this disclosure to analyze code repositories and user queries.

FIG. 2 is a block diagram of an example semantic analyzer of FIG. 1 to analyze code semantics.

FIG. 3 illustrates an example semantic analysis system.

FIG. 4 illustrates an example training system of FIG. 3 to generate a labeled training set.

FIG. 5 illustrates an example graph generating system of FIG. 3 to generate a graph.

FIG. 6 illustrates an example program-derived semantic graph.

FIG. 7 illustrates an example graph analysis system of FIG. 3 to analyze and answer user queries.

FIG. 8 is a flowchart representative of an example method that may be executed by the example semantic analyzer of FIGS. 1 and/or 2 to analyze code semantics.

FIG. 9 is a flowchart representative of an example method that may be executed by the example semantic analyzer of FIGS. 1 and/or 2 to construct a training dataset.

FIG. 10 is a flowchart representative of an example method that may be executed by the example semantic analyzer of FIGS. 1 and/or 2 to determine representations of semantic concepts.

FIG. 11 is a flowchart representative of an example method that may be executed by the example semantic analyzer of FIGS. 1 and/or 2 to recommend code snippets.

FIG. 12 is a block diagram of an example processing platform structured to execute the methods of FIGS. 8-11 and/or the example semantic analyzer of FIGS. 1 and/or 2.

FIG. 13 is a block diagram of an example software distribution platform to distribute software (e.g., software corresponding to the example computer readable instructions of FIGS. 8-11) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially real time” refers to real time +/−1 second and/or within the relative unit of time measurement.

### DETAILED DESCRIPTION

In recent years, advances in automated software development (e.g., machine learning (ML) techniques, etc.) have created new ways to write, maintain, test, and debug code. For example, machine programming (MP), defined herein as any system that automates some portion of software, envisions a future where ML and other automated reasoning techniques fully and/or partially automate the software development lifecycle.

One of the core challenges in MP is processing data. For example, the amount of data, in the form of code, has grown and is often stored in code repositories. For example, the amount of data on GITHUB® has grown nearly four orders of magnitude since its inception. The recent explosion of available source code data has presented new challenges, such as the ability for an MP system to extract user intention from code. Exacerbating this problem, new programming languages (e.g., Halide, Python, C, C++, etc.) continue to be developed with varying levels of semantic abstraction. As used herein, a semantic abstraction refers to the semantic meaning of the code data. For example, a first code block and a second code block (e.g., in different programming languages, in the same programming language, etc.) can be syntactically different but semantically identical (e.g., performing the same functionality).

Previous solutions have been proposed in an attempt to lift semantic meaning from code to automatically extract user intention. For example, previous solutions utilize single dimensional hierarchical structures. However, due to inherent semantic variabilities in code, previous solutions are no longer sufficient to determine user intention in code. For example, structural limitations of the code may create potential inconsistency and incompatibility in semantic representations from one programming language to other programming languages. For example, previous solutions are often limited to tree structures. Furthermore, previous solutions often capture more syntactic information than semantic information. For example, architectures that capture more syntactic information may capture implementation details that interfere with semantic meaning. Furthermore, the underlying assumptions of the code language may enforce sequential and parallel dependencies which interfere with code structure extraction.

Examples disclosed herein set forth a program-derived semantic graph (PSG) to capture semantics of code at several levels of granularity (e.g., abstraction levels). The PSG is a data-driven architecture, which is designed to evolve as programming languages evolve and new programming languages are created. In some examples, the nodes of the PSG correspond to one semantic concept and the PSG contains no duplicate nodes. Examples disclosed herein set forth self-supervised learning techniques for (i) constructing semantic concept nodes of a PSG and (ii) utilizing the PSG's hierarchical, semantic structure for code question-answering (QA) (e.g., in code similarity systems, etc.). For example, the PSG can aid in all stages of the software development life cycle, such as code recommendation for designing and building efficient code and code QA, bug detection for code testing, maintenance of code after deployment, etc.

In program semantic extraction, a graph is a more effective representation compared to trees. For example, graphs can effectively encode structural information (e.g., preserve syntactic meaning) through parent-child-sibling node hierarchy. While both graphs and trees can preserve hierarchical structure information, graphs are more general. This generality may be useful when working on open research questions (e.g., code similarity, etc.) where added flexibility may result in a broader exploration of solutions. Additionally, graphs can be effective representations for graph neural networks (GNNs) used to learn latent features and/or semantic information. For example, relational graph convolution networks (R-GCNs) are a class of GNNs that apply graph convolutions on highly multi-relational graphs (e.g., a PSG) to learn graph structure and semantic meaning. Furthermore, the semantics of some software abstraction levels may be more easily represented using a graph. For example, in Neural Code Comprehension, dependencies of data and control flow may take on a graph structure in which two nodes can be connected by more than one edge. Thus, a tree structure would be insufficient to capture such cyclic dependencies.

Example techniques disclosed herein include generating semantic concept nodes of a PSG in a self-supervised manner. Disclosed example techniques also include code QA for recommending code snippets to user code queries. Disclosed example techniques further include analyzing artifacts stored in code repositories (e.g., GITHUB®, etc.) and/or QA databases (e.g., StackOverflow, etc.) to determine semantic concept labels for code to generate a training dataset. Disclosed example techniques also include learning the embedding representations of non-deterministic semantic concepts of a first PSG (sometimes referred to herein as a base PSG) based on the training dataset. Disclosed example techniques further include hierarchically linking semantic concept representations of the embedding representations to generate a second PSG using semantic concept dependency information learned from deep neural network techniques (e.g., neural relational inference, etc.). Disclosed example techniques also include recommending code snippets to user queries for the task of code QA using the second PSG.

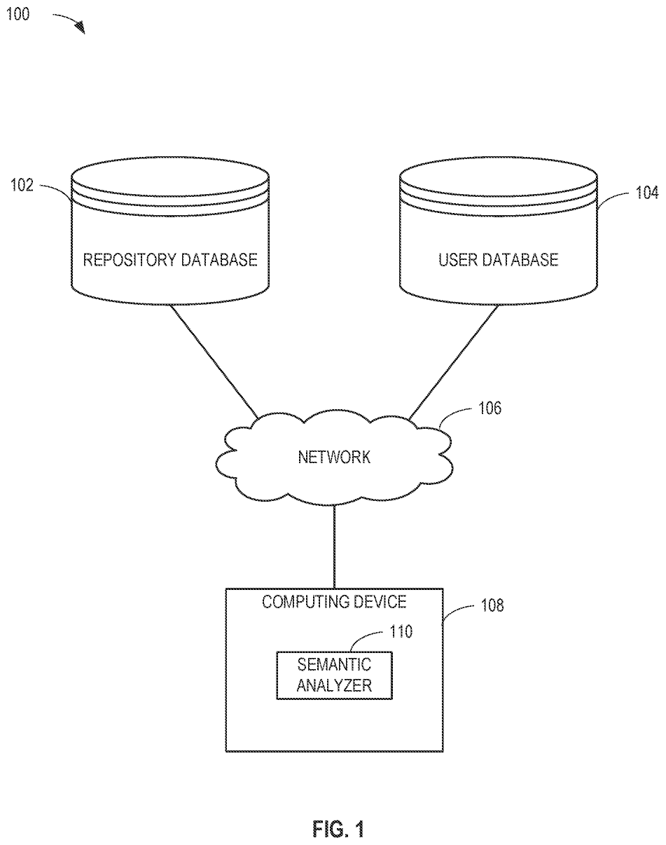

FIG. 1 illustrates an example code analysis system 100 constructed in accordance with the teachings of this disclosure to analyze code repositories and user queries. In the illustrated example of FIG. 1, the code analysis system 100 includes an example repository database 102, an example user database 104, an example network 106, an example computing device 108, and an example semantic analyzer 110.

In the illustrated example of FIG. 1, the repository database 102 includes programming data. For example, the repository database 102 stores source code data, such as code snippets (e.g., blocks of code), user queries, user answers, etc. For example, code snippets can include lines of source code, user comments in source code, etc. In some examples, the repository database 102 stores data from repositories such as GITHUB®, StackOverflow, etc.

In the illustrated example of FIG. 1, the user database 104 stores code questions. For example, the user database 104 stores user input (e.g., queries, etc.). For example, a user may ask “how do I code a for loop in Python?”, “how are C and C++ different?”, “what are the performance and memory footprint tradeoffs of each semantic implementation?”, etc.

In the illustrated example of FIG. 1, the network 106 facilitates communication between the repository database 102, the user database 104, and/or the computing device 108. In some examples, any number of the repository database 102 and/or the user database 104 can be communicatively coupled to the computing device 108 via the network 106. The communication provided by the network 106 can be via, for example, the Internet, an Ethernet connection, USB cable, Bluetooth, wireless communication technologies, etc.

In the illustrated example of FIG. 1, the computing device 108 communicates with the repository database 102 and the user database 104 through the network 106. In some examples, the computing device 108 contains the semantic analyzer 110. In the illustrated example of FIG. 1, the computing device 108 is a server, but alternatively may be an Internet gateway, a laptop, a cellular phone, a tablet, a smartwatch, a smart device, etc.

In the illustrated example of FIG. 1, the semantic analyzer 110 accesses and analyzes and/or otherwise parses the data stored in the repository database 102 and/or the user database 104. The semantic analyzer 110 labels the data stored in the repository database 102 with semantic concepts of a base PSG to generate a labeled training dataset. The semantic analyzer 110 inputs the labeled training dataset into a single deep neural network (DNN) or a collection of DNNs to generate embeddings of the semantic concepts of the labeled training dataset. The semantic analyzer 110 determines semantic concept dependencies between the embeddings to generate a PSG and recommend code snippets in response to user queries. In some examples, the semantic analyzer 110 is an application-specific integrated circuit (ASIC), and in some examples the semantic analyzer 110 is a field programmable gate array (FPGA). Alternatively, the semantic analyzer 110 can be software located in the microcode, firmware, and/or driver of the computing device 108.

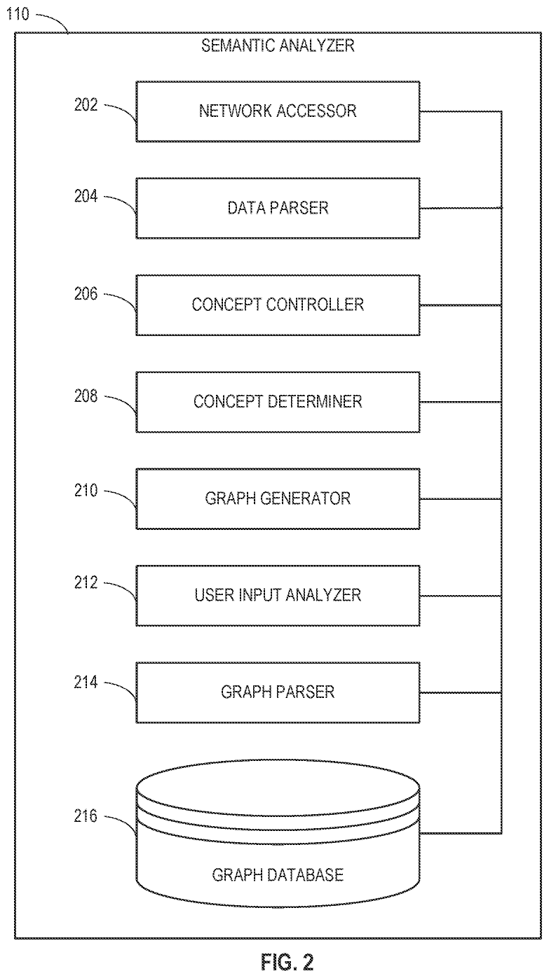

FIG. 2 is a block diagram of the example semantic analyzer 110 of FIG. 1 to analyze code semantics. In the illustrated example of FIG. 2, the semantic analyzer 110 includes an example network accessor 202, an example data parser 204, an example concept controller 206, an example concept determiner 208, the example graph generator 210, an example user input analyzer 212, an example graph parser 214, and an example graph database 216.

In the illustrated example of FIG. 2, the network accessor 202 accesses the data stored in the repository database 102 (FIG. 1) and/or the user database 104 (FIG. 1). In some examples, the network accessor 202 includes means for accessing data (sometimes referred to herein as data accessing means). The example means for accessing data is hardware. In some examples, the network accessor 202 accesses the repository database 102 and/or the user database 104 content in response to a query, on a manual basis, on a periodic basis, on a scheduled basis, on a push notification basis, on an interrupt basis, and/or on a polling basis. For example, the network accessor 202 may access the repository database 102 and/or the user database 104 once a month, once a quarter, once a year, for a single or collection of push/promotion requests, etc. to analyze code semantics. In some examples, the network accessor 202 harmonizes, normalizes, and/or otherwise formats the data accessed from the repository database 102 and/or the user database 104. In some examples, the network accessor 202 receives user input (e.g., stored in the user database 104). For example, the network accessor 202 receives queries from a user for code QA.

In the illustrated example of FIG. 2, the example data parser 204 analyzes the data obtained from the repository database 102 via the network accessor 202. In some examples, the data parser 204 includes means for parsing data (sometimes referred to herein as a data parsing means). The means for parsing data is hardware. The example data parser 204 determines whether the data contains code blocks. For example, the data parser 204 determines the data contains code blocks (e.g., code data) in response to identifying code syntax of programming languages. In some examples, the code data also includes text (e.g., code comments, etc.). If the data parser 204 determines the data includes code, the data parser 204 processes the code data for artifacts. For example, the artifacts can be comments, file name(s), function name(s), unit tests, specification(s), LaTeX document(s), Unified Modeling Language (UML) sequence diagram(s), graph description language (e.g., DOT, etc.), etc. In some examples, the data parser 204 processes a code file using code structure analysis defined by the syntax of the programming language. Additionally or alternatively, if the code is able to be compiled, the data parser 204 can use dynamic analysis techniques (e.g., execution trace analysis, program input/output analysis, etc.) to process the code file. If the data parser 204 determines the data does not include code blocks (e.g., text data), the data parser 204 processes the text data using natural language comprehension. That is, the data parser 204 processes the text data to identify words, phrases, etc. in the text data.

In the illustrated example of FIG. 2, the example concept controller 206 intersects (e.g., compares, compares and matches, etc.) the data with semantic concepts. In some examples, the concept controller 206 includes means for controlling concepts (sometimes referred to herein as a concept controlling means). The means for controlling concepts is hardware. That is, the concept controller 206 assigns semantic concept labels (e.g., semantic labels) to the artifacts and/or processed text generated by the example data parser 204. In some examples, the concept controller 206 obtains a base PSG stored in the example graph database 216 to determine known semantic labels. For example, the base PSG is stored in the graph database 216 and includes initial semantic concepts as user-defined strings. In examples disclosed herein, the base PSG is not an exhaustive PSG. That is, the base PSG may be missing semantic concept nodes, edges, etc. Thus, in some examples, the example concept controller 206 updates (e.g., refines) the base PSG to add semantic concept nodes, form edges between semantic concept nodes, etc. to use previously visited signatures to note wild card variants to provide opportunistic recommendations on ranked possible intent.

In some examples, the example concept controller 206 identifies semantic concept dependencies based on text data that has been intersected with semantic concepts. For example, the concept controller 206 identifies a first semantic concept is dependent on a second semantic concept based on a comment in the text data. The example concept controller 206 combines the code data and text data that has been compared and matched with semantic concepts to generate code examples labeled with semantic concepts. That is, the concept controller 206 generates a training dataset. In examples disclosed herein, the training dataset is a labeled training dataset (e.g., the code data and/or text data is labeled with semantic concepts).

In the illustrated example of FIG. 2, the example concept determiner 208 classifies the input training dataset into different semantic concepts. In some examples, the concept determiner 208 includes means for determining concepts (sometimes referred to herein as a concept determining means). The means for determining concepts is hardware. For example, the concept determiner 208 analyzes the labeled training dataset (e.g., blocks of code, blocks of text, etc.) and determines semantic concept categories. For example, the concept determiner 208 determines one or more blocks of code corresponds to the same semantic concept. The example concept determiner 208 determines semantic concept categories based on the semantic concepts of the base PSG stored in the example graph database 216. The example concept determiner 208 passes the input training dataset through a DNN to generate embeddings. As used herein, an embedding is a mapping of discrete variables to a vector of continuous numbers. For example, the concept determiner 208 inputs a block of code through a DNN to generate a block embedding. In examples disclosed herein, a block embedding (e.g., a program-level embedding) summarizes the learned representation of a semantic concept of the block of data of the input training dataset. For example, a block embedding is a vector of numbers representing the learned semantic concept of the corresponding block of code and/or text. In some examples, the concept determiner 208 stores the block embeddings in the graph database 216. For example, the concept determiner 208 can input the input training dataset through a collection of networks, recurrent neural network (RNN), a graph neural network (GNN), etc.

The example concept determiner 208 generates semantic embeddings of semantic concepts. For example, a semantic embedding is a vector of numbers representing the semantic concept of one or more block embeddings. That is, the example concept determiner 208 aggregates (e.g., by pooling, averaging, summation, etc.) the block embeddings (e.g., the neural network learned representations) of a semantic concept. In some examples, the semantic embeddings are programming-language agnostic (e.g., the semantic embeddings do not contain program-level information). In some examples, the concept determiner 208 stores the semantic embeddings in the graph database 216.

In examples disclosed herein, the DNN is trained on a number of code examples, because semantic concepts can be implemented in multiple syntactically different ways. For example, a semantic concept can be sorting. Sorting (e.g., tasks/operations to place information in a particular order (e.g., numerically increasing, numerically decreasing, alphabetic, etc.)) can be implemented recursively, iteratively, with different data structures, different sorting algorithms, etc. To account for these various semantically identical but syntactically different codes, the semantic embedding representation for a semantic concept is an aggregation of the input code training example representations (e.g., the block embeddings) for that semantic category.

For example, the input training dataset may include three code blocks corresponding to one semantic concept of the base PSG. The concept determiner 208 passes the three code blocks corresponding to the semantic concept through DNNs to generate three block embeddings of the semantic concept. The example concept determiner 208 aggregates the three block embeddings to generate a semantic embedding of the semantic concept. That is, the semantic embedding of the semantic concept is a higher level abstraction layer than the block embeddings. For example, the semantic concept may be a sum operation. The semantic embedding of the sum operation can be an aggregation of one or more block embeddings corresponding to code blocks of the sum operation (e.g., code blocks in different programming languages, code blocks in different syntaxes, etc.).

In the illustrated example of FIG. 2, the example graph generator 210 determines higher-order semantic concepts. In some examples, the graph generator 210 includes means for generating graphs (sometimes referred to herein as graph generating means). The means for generating graphs is hardware. That is, the graph generator 210 determines different abstraction levels of semantic concepts. For example, the graph generator 210 aggregates semantic embeddings of one or more semantic concepts to generate higher-order semantic embeddings. That is, the graph generator 210 determines semantic concept dependency edges. As used herein, a first semantic concept that is dependent on a second semantic concept is a relatively higher abstraction level. For example, a first semantic concept can be computation and a second semantic concept can be summation. Thus, the semantic embedding corresponding to the computation semantic concept is dependent on the semantic embedding corresponding to the summation semantic concept. In some examples, the graph generator 210 passes the semantic embeddings through a neural network to determine higher-order semantic embeddings. For example, the graph generator 210 determines semantic concept dependency edges through deep learning techniques (e.g., neural relational inference, etc.).

In the illustrated example of FIG. 2, the example user input analyzer 212 analyzes user input. In some examples, the user input analyzer 212 includes means for analyzing user input (sometimes referred to herein as a user input analyzing means). The means for analyzing user input is hardware. For example, the user input analyzer 212 accesses the data stored in the user database 104 (e.g., user input data) via the network accessor 202. In some examples, the user input analyzer 212 passes the user input data through a DNN to extract meaning from the text. For example, the user input analyzer 212 performs natural language comprehension on the user input data. The example user input analyzer 212 identifies semantic concepts in the user input data. For example, the user input data may include a user query and the user input analyzer 212 identifies one or more semantic concepts associated with the user query (e.g., semantic concepts of interest).

In the illustrated example of FIG. 2, the example graph parser 214 outputs code snippets to a user based on the user input data and PSG via self-supervised learning. In some examples, the graph parser 214 includes means for parsing graphs (sometimes referred to herein as a graph parsing means). The means for parsing graphs is hardware. For example, the graph parser 214 accesses the base PSG and the PSG generated by the graph generator 210 stored in the graph database 216. The example graph parser 214 identifies the semantic concepts of interest (e.g., included in a user query) in the PSG. Based on the PSG structure (e.g., semantic concept dependency edges), the graph parser 214 identifies missing semantic concepts of interest. For example, the user query may include a semantic concept representation in the base PSG, which has a semantic concept dependency in the PSG. The graph parser 214 identifies the semantic concept in the PSG and determines the semantic concept dependency is not included in the user query. Thus, the graph parser 214 outputs the missing semantic concept to the user. For example, the graph parser 214 may output code snippets from the labeled training data associated with the missing semantic concept of interest.

In the illustrated example of FIG. 2, the example graph database 216 stores graphs. For example, the graph database 216 stores a base PSG including semantic concepts. The graph database 216 stores PSGs generated by the graph generator 210.

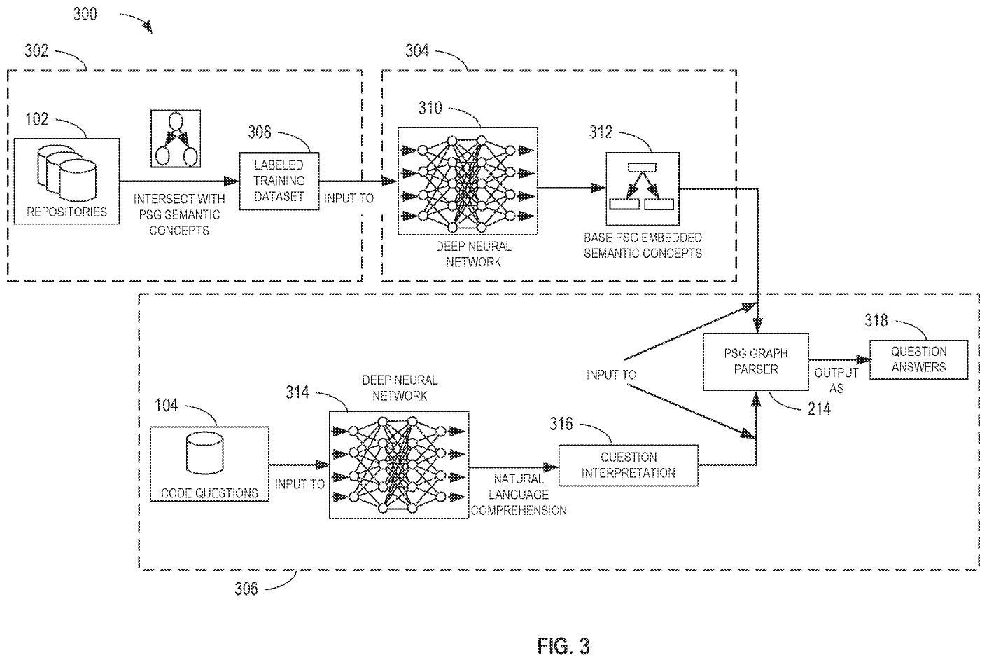

FIG. 3 illustrates an example semantic analysis system 300. The example semantic analysis system 300 generates PSGs and performs question-answering based on the PSGs. The example semantic analysis system 300 includes an example training system 302, an example graph generating system 304, and an example graph analysis system 306.

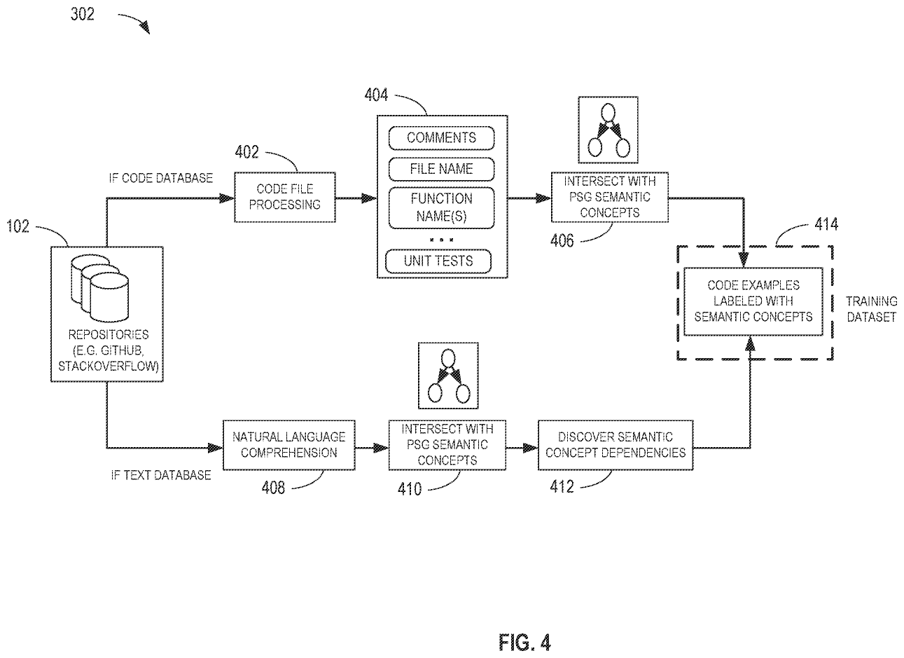

The example training system 302 includes the example repository database 102 (FIG. 1). For example, the repository database 102 stores data of code repositories (e.g., GITHUB®, StackOverflow, etc.). The repository database 102 stores code data and/or text data. The example training system 302 includes an example labeled training dataset 308. In examples disclosed herein, the example concept controller 206 (FIG. 2) generates the labeled training dataset 308. For example, the concept controller 206 intersects the code data and/or the text data stored in the repository database 102 with semantic concepts (e.g., semantic concepts of a base PSG stored in the graph database 216 of FIG. 2). The example training system 302 is described in further detail below in connection with FIG. 4.

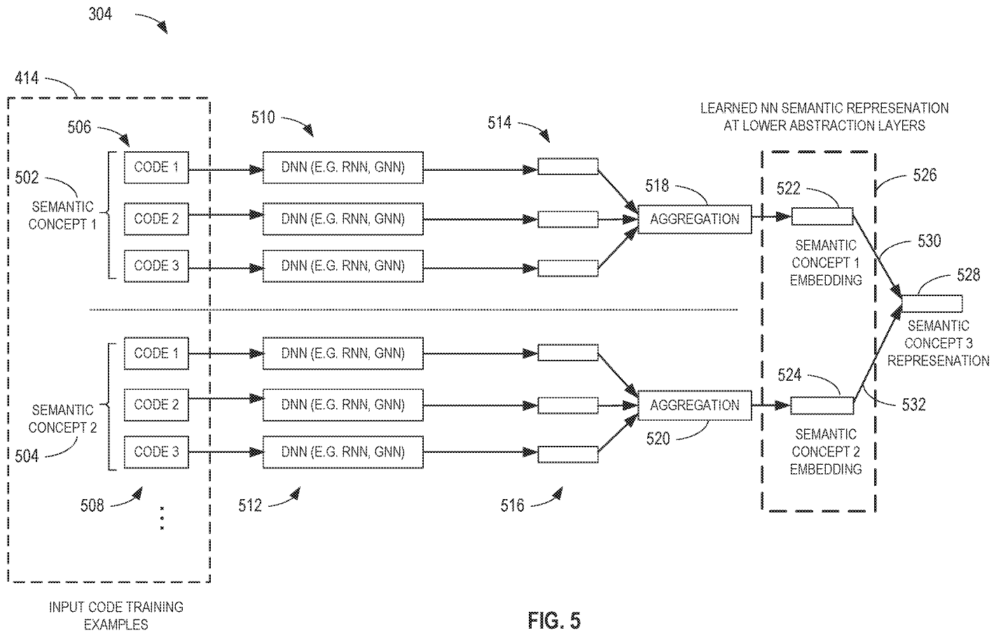

The example graph generating system 304 includes an example first DNN 310. For example, the concept determiner 208 (FIG. 2) passes the labeled training dataset 308 through the first DNN 310 to generate semantic concept representations (e.g., semantic embeddings) of the labeled semantic concepts in the labeled training dataset 308. The example graph generator 210 (FIG. 2) generates an example PSG 312 based on the semantic concept representations. The example graph generating system 304 is described in further detail below in connection with FIG. 5.

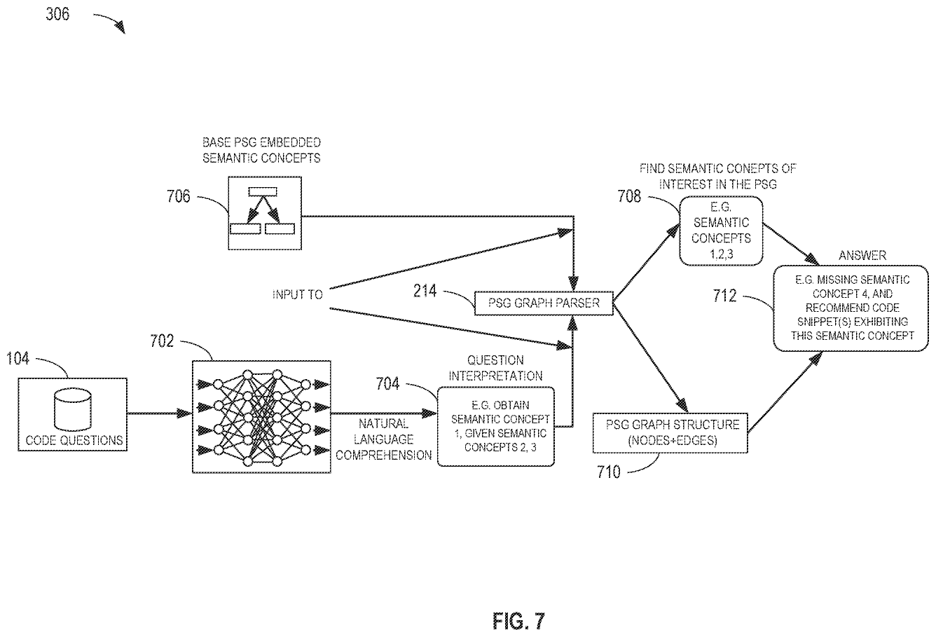

The example graph analysis system 306 includes the example user database 104 (FIG. 1). For example, the user database 104 stores code questions received from a user. The example graph analysis system 306 includes an example second DNN 314. The example user input analyzer 212 (FIG. 2) inputs the code questions into the second DNN 314 to perform natural language comprehension and user input analysis. At block 316, the user input analyzer 212 performs question interpretation. For example, the user input analyzer 212 identifies semantic concepts included in the code questions (e.g., semantic concept of interest). The example graph parser 214 (FIG. 2) accesses the PSG 312 to identify missing semantic concepts based on the semantic concepts of interest included in the code questions. The example graph parser 214 outputs example question-answers 318. For example, the question-answers 318 can include the missing semantic concepts and/or code snippets associated with the missing semantic concepts (e.g., stored in the labeled training dataset 308). The example graph analysis system 306 is described in further detail below in connection with FIG. 7.

FIG. 4 illustrates the example training system 302 of FIG. 3 to generate a labeled training dataset. The example training system 302 includes the example repository database 102 (FIG. 1). The example network accessor 202 (FIG. 2) accesses the data stored in the repository database 102. The example data parser 204 (FIG. 2) analyzes the data to determine whether the data includes code data. If the example data parser 204 determines the data includes code data, at block 402, the example data parser 204 performs code file processing to generate example artifacts 404. For example, the artifacts 404 include comments, file names, function names, unit tests, specification(s), LaTeX document(s), UML sequence diagram(s), graph description language (e.g., DOT, etc.), etc. At block 406, the example concept controller 206 (FIG. 2) compares and matches the artifacts 404 with semantic concepts. For example, the concept controller 206 accesses a base PSG stored in the graph database 216 (FIG. 2) to determine semantic concepts. The concept controller 206 intersects the artifacts 404 with the semantic concepts of the base PSG.

If the example data parser 204 determines the data does not include code data, at block 408, the example data parser 204 performs natural language comprehension on the data to generate processed text data. For example, the data parser 204 analyzes the data to identify words, phrases, references to documentation, sequence diagrams, etc. At block 410, the example concept controller 206 intersects the processed text data with semantic concepts of the base PSG. At block 412, the example concept controller 206 identifies semantic concept dependencies. For example, the text data may contain user analysis that defines semantic concept dependencies.

The example concept controller 206 aggregates the matched code data and text data to generate an example labeled training dataset 414. For example, the concept controller 206 assign semantic concept labels to the code data and/or text data. Thus, the labeled training dataset 414 includes code data and/or text data labeled with semantic concepts of a base PSG with corresponding reference documents.

FIG. 5 illustrates the example graph generating system 304 of FIG. 3 to generate a PSG. For example, the graph generating system 304 receives the labeled training dataset 414 (FIG. 4). In the illustrated example of FIG. 5, the labeled training dataset 414 includes an example first semantic concept 502 and an example second semantic concept 504. While the illustrated example of FIG. 5 includes two semantic concepts, examples disclosed herein can include a fewer or greater number of semantic concepts. The example first semantic concept 502 includes example code snippets 506. The example second semantic concept 504 includes example code snippets 508. For example, the code snippets 506 include three blocks of code. In examples disclosed herein, the blocks of code of the code snippets 506 are syntactically different but semantically identical (e.g., corresponding to the first semantic concept 502). For example, the first semantic concept 502 can correspond to the summation semantic concept and the code snippets 506 can be three different programming languages implementing a summation. While the illustrated example of FIG. 5 includes three blocks of code for the example code snippets 506, 508, examples disclosed herein can include a fewer or greater number of code blocks for each code snippet 506, 508. For example, the code snippets 506 can include two code blocks and the code snippets 508 can include three code blocks, the code snippets 506 can include five code blocks and the code snippets 508 can include two code blocks, etc.

The example concept determiner 208 (FIG. 2) inputs the code snippets 506 into example DNNs 510. The example concept determiner 208 inputs the code snippets 508 into example DNNs 512. In the illustrated example of FIG. 5, the concept determiner 208 inputs the code snippets 506, 508 into a collection of DNNs (e.g., the DNNs 510, 512). In examples disclosed herein, the DNNs 510, 512 can be a RNN, a GNN, etc. The DNNs 510 generate example block embeddings 514 and the DNNs 512 generate example block embeddings 516. The example block embeddings 514 summarize the learned representation of the example first semantic concept 502 of the input code snippets 506. The example block embeddings 516 summarize the learned representation of the example second semantic concept 504 of the input code snippets 508. For example, for each code snippet of the example code snippets 506, 508, the DNNs 510, 512 output a block embedding representing the corresponding semantic concept.

At block 518, the example concept determiner 208 aggregates the block embeddings 514 to generate an example first semantic embedding 522. For example, the concept determiner 208 aggregates (e.g., pools, averages, sums, etc.) the block embeddings 514 corresponding to the first semantic concept 502. At block 520, the example concept determiner 208 aggregates the block embeddings 516 to generate an example second semantic embedding 524. For example, the concept determiner 208 aggregates the block embeddings 516 corresponding to the second semantic concept 504.

In the illustrated example of FIG. 5, the first semantic embedding 522 and the second semantic embedding 524 are an example first abstraction layer 526. For example, the first semantic embedding 522 and the second semantic embedding 524 represent semantic concepts at the same abstraction level. For example, the first semantic concept 502 of the first semantic embedding 522 can be the summation operation and the second semantic concept 504 of the second semantic embedding 524 can be the division operation. The example graph generator 210 (FIG. 2) aggregates the first semantic embedding 522 and the second semantic embedding 524 to connect to a third semantic embedding 528 to form a PSG. For example, the third semantic embedding 528 is associated with code snippets of a third semantic concept (not illustrated). The example graph generator 210 forms an example first semantic concept dependency edge 530 and an example second semantic concept dependency edge 532. That is, the first semantic concept dependency edge 530 defines the semantic concept dependency between the first semantic embedding 522 and the third semantic embedding 528. The second semantic concept dependency edge 532 defines the semantic concept dependency between the second semantic embedding 524 and the third semantic embedding 528. The example third semantic embedding 528 is a second, more general abstraction layer with respect to the first abstraction layer 526. For example, the third semantic embedding 528 can correspond to the computation semantic concept. Thus, the first semantic concept 502 of summation and the second semantic concept 504 of division are a lower abstraction layer with respect to the third semantic concept of computation. The third semantic embedding 528 can be associated with the code snippets 506, 508 of the first semantic embedding 522 and the second semantic embedding 524. The third semantic embedding 528 can additionally or alternatively be associated with code snippets of other semantic concepts of computation, such as multiplication, exponents, arithmetic transformations, etc.

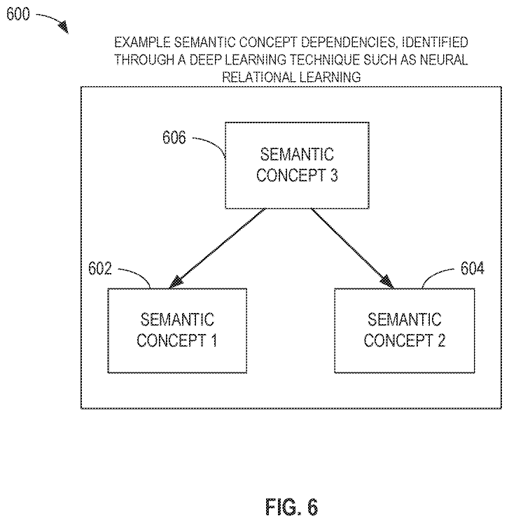

FIG. 6 illustrates an example program-derived semantic graph (PSG) 600. For example, the graph generator 210 (FIG. 2) generates the PSG 600. The example PSG 600 includes an example first semantic concept 602, an example second semantic concept 604, and an example third semantic concept 606. In the illustrated example of FIG. 6, the third semantic concept 606 is dependent on the first semantic concept 602 and the second semantic concept 604. That is, the third semantic concept 606 is a higher (e.g., more general) abstraction level than the first semantic concept 602 and the second semantic concept 604. For example, the third semantic concept 606 can be data structures, the first semantic concept 602 can be arrays, and the second semantic concept 604 can be linked lists. In this example, the third semantic concept 606 includes the first semantic concept 602 and the second semantic concept 604. For example, the first semantic concept 602 (e.g., arrays) and the second semantic concept 604 (e.g., linked lists) are types of the third semantic concept 606 (e.g., data structures).

FIG. 7 illustrates the example graph analysis system 306 of FIG. 3 to analyze and answer user queries. The example graph analysis system 306 includes the example user database 104 (FIG. 1). For example, the user database 104 stores user queries. The example user input analyzer 212 (FIG. 2) inputs user input through an example DNN 702 to interpret the user input. For example, the DNN 702 performs natural language comprehension on the user input. At block 704, the example user input analyzer 212 performs question interpretation. For example, the user input analyzer 212 identifies semantic concepts of interest included in the user query. In the illustrated example of FIG. 3, the user input analyzer 212 determines the user query includes a first semantic concept given a second semantic concept and a third semantic concept. For example, the first semantic concept can be structures, the second semantic concept can be sorting, and the third semantic concept can be searching.

The example graph parser 214 (FIG. 2) obtains the semantic concepts of interest and an example PSG 706 (e.g., generated by the example graph generator 210 of FIG. 2). At block 708, the example graph parser 214 identifies the semantic concepts of interest in the PSG 706. For example, the graph parser 214 searches the PSG 706 to identify the semantic concepts of interest. At block 710, the example graph parser 214 identifies the PSG structure corresponding to the semantic concepts of interest. For example, the graph parser 214 identifies nodes (e.g., semantic concepts) and/or edges (e.g., dependencies) of the PSG 706. At block 712, the example graph parser 214 identifies missing semantic concepts and outputs code snippets associated with the missing semantic concepts. For example, the graph parser 214 determines the semantic concepts of interest (e.g., the first, second, and third semantic concept) are associated with a fourth semantic concept that was not included in the user query. For example, the second and third semantic concepts may be dependent on the fourth semantic concept (e.g., the PSG 706 includes semantic concept dependency edges from the second and third semantic concepts to the fourth semantic concept). For example, the fourth semantic concept may be arrays. The graph parser 214 outputs code snippets associated with the fourth semantic concept to the user.

While an example manner of implementing the semantic analyzer 110 of FIG. 1 is illustrated in FIG. 2, one or more of the elements, processes and/or devices illustrated in FIG. 2 may be combined, divided, re-arranged, omitted, eliminated and/or implemented in any other way. Further, the example network accessor 202, the example data parser 204, the example concept controller 206, the example concept determiner 208, the example graph generator 210, the example user input analyzer 212, the example graph parser 214, the example graph database 216 and/or, more generally, the example semantic analyzer 110 of FIG. 2 may be implemented by hardware, software, firmware, microcode, driver, and/or any combination of hardware, software and/or firmware. Thus, for example, any of the example network accessor 202, the example data parser 204, the example concept controller 206, the example concept determiner 208, the example graph generator 210, the example user input analyzer 212, the example graph parser 214, the example graph database 216 and/or, more generally, the example semantic analyzer 110 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, network accessor 202, the example data parser 204, the example concept controller 206, the example concept determiner 208, the example graph generator 210, the example user input analyzer 212, the example graph parser 214, the example graph database 216 is/are hereby expressly defined to include a non-transitory computer readable storage device or storage disk such as a memory, a digital versatile disk (DVD), a compact disk (CD), a Blu-ray disk, etc. including the software and/or firmware. Further still, the example semantic analyzer 110 of FIG. 2 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, interrupt basis, pooling basis, or collected push requests, and/or one-time events.

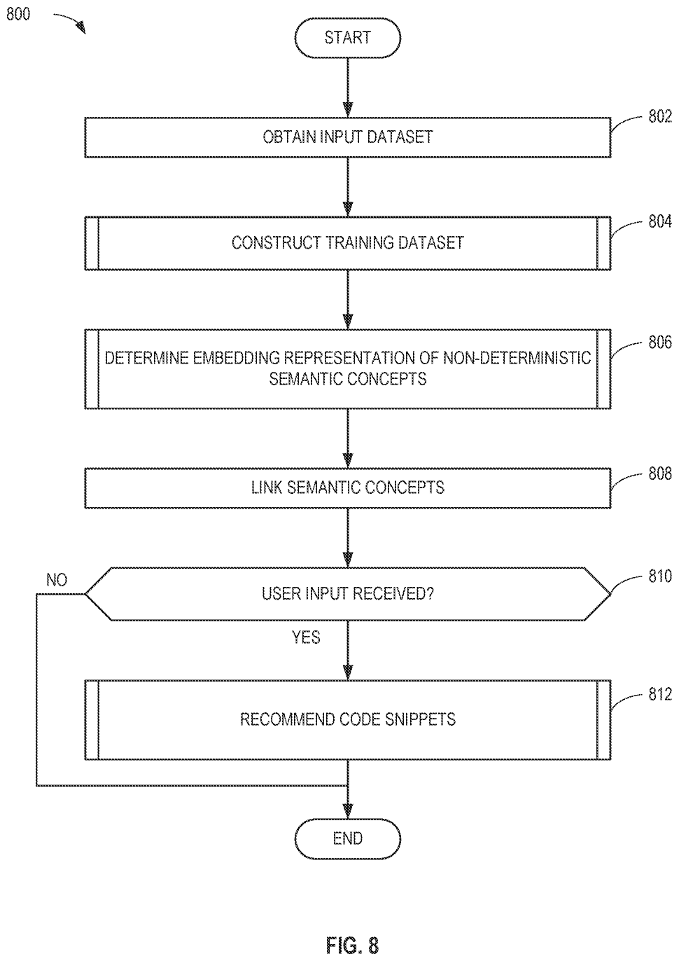

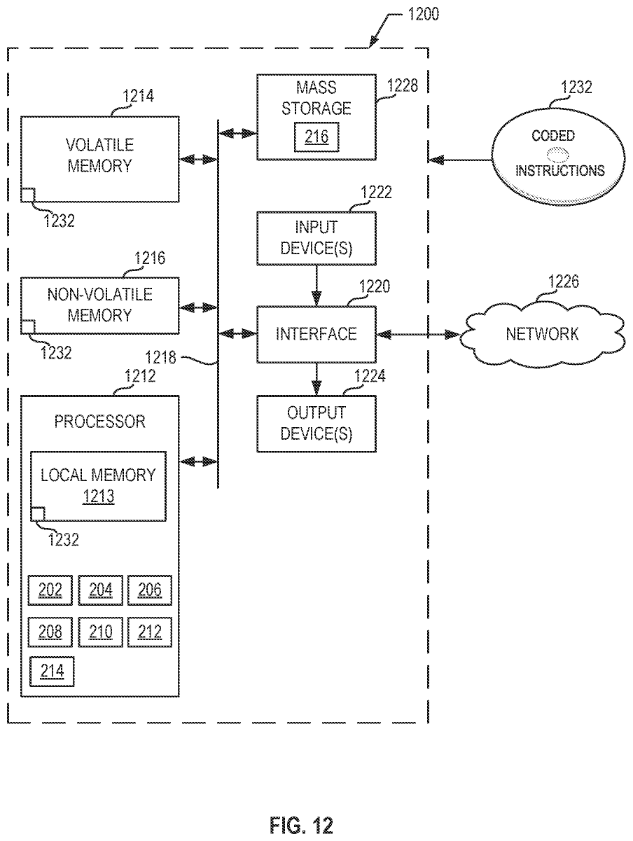

Flowcharts representative of example hardware logic, machine readable instructions, hardware implemented state machines, and/or any combination thereof for implementing the semantic analyzer 110 of FIGS. 1 and/or 2 are shown in FIGS. 8-11. The machine readable instructions may be one or more executable programs or portion(s) of an executable program for execution by a computer processor and/or processor circuitry, such as the processor 1212 shown in the example processor platform 1200 discussed below in connection with FIG. 12. The program may be embodied in software stored on a non-transitory computer readable storage medium such as a CD-ROM, a floppy disk, a hard drive, a solid state drive, persistent device memory, a DVD, a Blu-ray disk, or a memory associated with the processor 1212, but the entire program and/or parts thereof could alternatively be executed by a device other than the processor 1212 and/or embodied in firmware or dedicated hardware. Further, although the example program is described with reference to the flowcharts illustrated in FIGS. 8-11, many other methods of implementing the example semantic analyzer 110 may alternatively be used. For example, the order of execution, parallelism, scheduling, asymmetric/symmetric processing of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, vectored format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, scheduling, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), re-programmable specification, etc. in order to execute the instructions on a particular computing device or other device. In another example, the machine readable instructions may need to be configured (e.g., settings stored, data input, network addresses recorded, customizable processing unit, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, VHDL, Verilog, System Verilog, dynamic language system, etc.

As mentioned above, the example processes of FIGS. 8-11 may be implemented using fixed, flexible, or extended executable instructions (e.g., computer and/or machine readable instructions) stored on a non-transitory computer and/or machine readable medium such as a hard disk drive, solid state drive, a flash memory, phase change memory, a read-only memory, a compact disk, a digital versatile disk, a cache, scratchpad memory, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 8 is a flowchart 800 representative of example machine-readable instructions that may be executed to implement the example semantic analyzer 110 of FIGS. 1 and/or 2. The example machine-readable instructions of FIG. 8 begins at block 802 at which the network accessor 202 (FIG. 2) obtains an input dataset. For example, the network accessor 202 accesses data stored in the repository database 102 (FIG. 1). In some examples, the repository database 102 includes code data and/or text data.

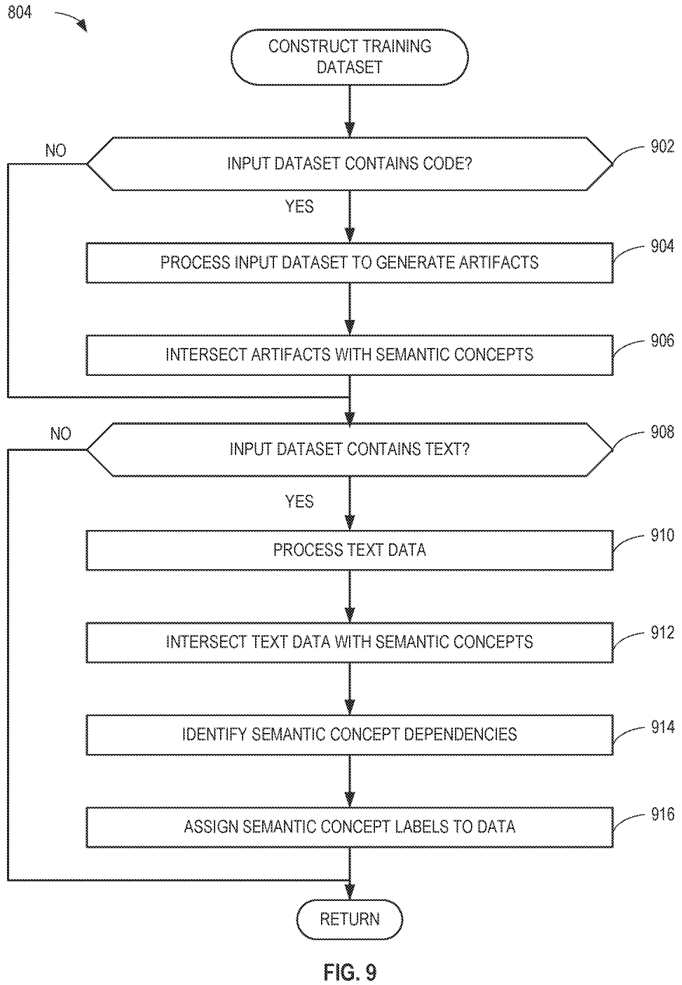

The example semantic analyzer 110 constructs a training dataset (block 804). For example, the example data parser 204 (FIG. 2) analyzes the input dataset to determine whether the dataset includes code. The example concept controller 206 (FIG. 2) intersects the input dataset with semantic concepts of a base PSG stored in the example graph database 216 (FIG. 2). For example, the concept controller 206 compares and matches the input dataset with the semantic concepts of the base PSG. The example concept controller 206 labels the input dataset with semantic concept labels to generate a labeled training dataset. Further example instructions that may be used to implement block 804 are described below in connection with FIG. 9.

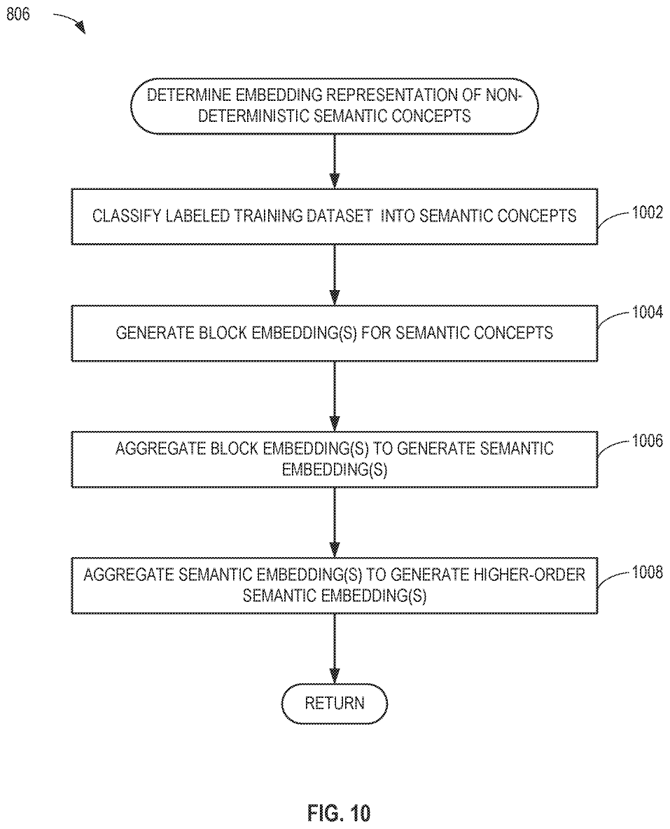

The example concept determiner 208 (FIG. 2) determines embedding representation(s) of non-deterministic semantic concepts (block 806). For example, the concept determiner 208 obtains and inputs the labeled training dataset into DNNs to generate block embeddings. The example concept determiner 208 aggregates the block embeddings based on the associated semantic concept of the code blocks and/or text blocks. For example, the concept determiner 208 generates semantic embeddings based on the aggregated block embeddings. Further example instructions that may be used to implement block 806 are described below in connection with FIG. 10.

The example graph generator 210 (FIG. 2) links semantic embeddings (block 808). For example, the graph generator 210 aggregates the semantic embeddings to generate semantic concept dependency edges. In some examples, the example graph generator 210 identifies semantic concept dependency edges through deep learning techniques (e.g., neural relational inference, etc.).

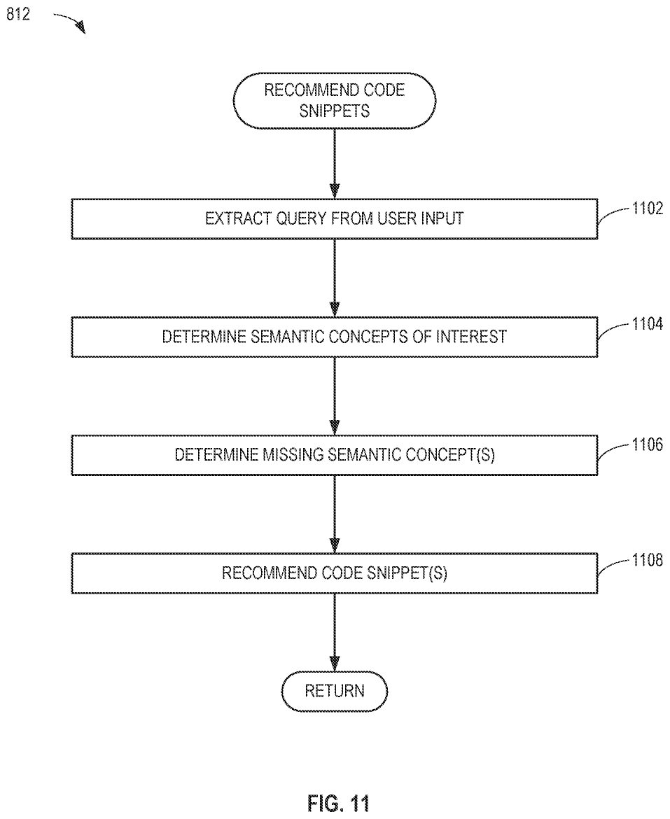

The example user input analyzer 212 (FIG. 2) determines whether user input has been received (block 810). For example, the user input analyzer 212 determines whether user queries are stored in the user database 104 (FIG. 1) via the network accessor 202. If, at block 810, the example user input analyzer 212 determines user input has not been received, the program 800 ends. If, at block 810, the user input analyzer 212 determines user input has been received, the example graph parser 214 (FIG. 2) recommends code snippets (block 812). For example, the user input analyzer 212 identifies semantic concepts in the user queries. The example graph parser 214 identifies missing semantic concepts and outputs code snippets associated with the missing semantic concepts. Further example instructions that may be used to implement block 812 are described below in connection with FIG. 11.

FIG. 9 is a flowchart 804 representative of example machine-readable instructions that may be executed to implement example semantic analyzer 110 of FIGS. 1 and/or 2. The example machine-readable instructions of FIG. 9 begin at block 902 at which the example data parser 204 (FIG. 2) determines whether the input dataset includes code. For example, the example data parser 204 analyzes the input dataset for code syntax (e.g., function names, variable declarations, etc.). If, at block 902, the example data parser 204 determines the input dataset does not include code, the program 804 proceeds to block 908. If, at block 902, the example data parser 204 determines the input dataset does include code, the example data parser 204 processes the input dataset to generate artifacts (block 904). For example, the data parser 204 identifies code comments, file names, function names, etc.

The example concept controller 206 (FIG. 2) intersects the artifacts with semantic concepts (block 906). For example, the concept controller 206 accesses a base PSG stored in the example graph database 216 (FIG. 2) to determine semantic concepts. The example concept controller 206 identifies the semantic concepts in the code artifacts.

The example data parser 204 determines whether the input dataset contains text (block 908). If, at block 908, the example data parser 204 determines the input dataset does not contain text, the program 804 returns to the program 800 of FIG. 8. If, at block 908, the example data parser 204 determines the input dataset does contain text, the example data parser 204 processes the text data (block 910). For example, the data parser 204 processes the text data using natural language comprehension.

The example concept controller 206 intersects the text data with semantic concepts (block 912). For example, the concept controller 206 accesses the base PSG stored in the graph database 216 to identify semantic concepts and intersects the semantic concepts with the processed text. The example concept controller 206 identifies semantic concept dependencies (block 914). For example, the concept controller 206 analyzes the identified semantic concepts in the text data and determines whether there are semantic concept dependencies based on the processed text.

The example concept controller 206 assigns semantic concept labels to the data (block 916). For example, the concept controller 206 assigns semantic concept labels to the code data and/or the text data to generate a labeled training dataset. Control returns to the program 800 of FIG. 8.

FIG. 10 is a flowchart 806 representative of example machine-readable instructions that may be executed to implement the example semantic analyzer 110 of FIGS. 1 and/or 2. The example machine-readable instructions of FIG. 10 begin at block 1002 at which the example concept determiner 208 (FIG. 2) classifies the labeled training dataset into semantic concepts. For example, the concept determiner 208 groups code blocks and/or text blocks based on semantic concept labels.

The example concept determiner 208 generates block embedding(s) for semantic concepts (block 1004). For example, the concept determiner 208 inputs the code blocks and/or text blocks into one DNN or a collection of DNNs to generate block embeddings. The example concept determiner 208 aggregates the block embedding(s) to generate semantic embedding(s) (block 1006). For example, the concept determiner 208 aggregates (e.g., pools, averages, sums, etc.) block embeddings labeled with the same semantic concept to generate a semantic embedding representative of the semantic concept.

The example graph generator 210 (FIG. 2) aggregates semantic embedding(s) to generate higher-order semantic embeddings (block 1008). For example, the graph generator 210 determines semantic concept dependency edges between semantic embeddings to generate a PSG. In some examples, the graph generator 210 identifies semantic concept dependency edges through a deep learning technique. Control returns to the program 800 of FIG. 8.

FIG. 11 is a flowchart 812 representative of example machine-readable instructions that may be executed to implement the example semantic analyzer 110 of FIGS. 1 and/or 2. The example machine-readable instructions of FIG. 11 begin at block 1102 at which the example user input analyzer 212 (FIG. 2) extracts a query from user input. For example, the user input analyzer 212 accesses input data from the user database 104 (FIG. 1) via the network accessor 202 (FIG. 2). The example user input analyzer 212 passes the input data into a DNN to perform natural language comprehension.

The example user input analyzer 212 determines semantic concept(s) of interest (block 1104). For example, the user input analyzer 212 accesses a base PSG stored in the graph database 216 (FIG. 2) to identify semantic concepts in the user query.

The example graph parser 214 (FIG. 2) identifies missing semantic concept(s) (block 1106). For example, the graph parser 214 accesses a PSG stored in the graph database 216 (e.g., generated by the graph generator 210 of FIG. 2). The example graph parser 214 identifies the nodes and/or edges in the PSG corresponding to the semantic concept of interest in the user query. The example graph parser 214 identifies semantic concepts associated with the semantic concept(s) of interest that were not included in the user query (e.g., semantic concepts associated with a semantic concept dependency edge from the semantic concept(s) of interest).

The example graph parser 214 recommends code snippets (block 1108). For example, the graph parser 214 identifies code snippets associated with the missing semantic concept(s) and outputs the code snippets to the user. Control returns to the program 800 of FIG. 8.

FIG. 12 is a block diagram of an example processor platform 1200 structured to execute the instructions of FIGS. 8-11 to implement the semantic analyzer 110 of FIGS. 1 and/or 2. The processor platform 1200 can be, for example, a server, a personal computer, a workstation, a self-learning machine (e.g., a neural network), a mobile device (e.g., a cell phone, a smart phone, a tablet such as an iPad, a smart watch, etc.), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example network accessor 202, the example data parser 204, the example concept controller 206, the example concept determiner 208, the example graph generator 210, the example user input analyzer 212, and the example graph parser 214.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), Phase Change Memory, and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, Wireless Interface, a universal serial bus (USB), a Bluetooth® interface, a near field communication (NFC) interface, Direct Link Interface, and/or a PCI express interface.

In the illustrated example, one or more input devices 1222 are connected to the interface circuit 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1220 of the illustrated example, thus, typically includes a graphics driver card, a graphics driver chip and/or a graphics driver processor.

The interface circuit 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1226. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1200 of the illustrated example also includes one or more mass storage devices 1228 for storing software and/or data. Examples of such mass storage devices 1228 include floppy disk drives, hard drive disks, a solid state drive, compact disk drives, Blu-ray disk drives, redundant array of independent disks (RAID) systems, and digital versatile disk (DVD) drives.

The machine executable instructions 1232 of FIGS. 8-11 may be stored in the mass storage device 1228, in the volatile memory 1214, in the non-volatile memory 1216, and/or on a removable non-transitory computer readable storage medium such as a CD or DVD.

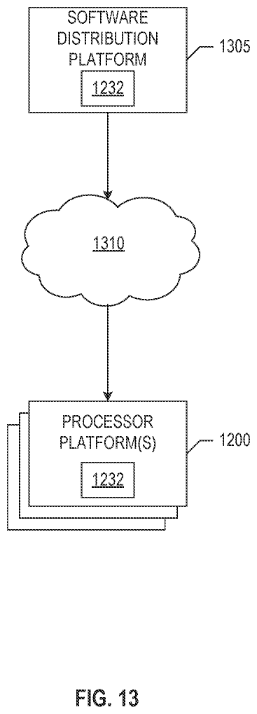

A block diagram illustrating an example software distribution platform 1305 to distribute software such as the example computer readable instructions 1232 of FIG. 12 to third parties is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1232 of FIG. 12. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the computer readable instructions 1232, which may correspond to the example computer readable instructions 1232 of FIGS. 8-11, as described above. The one or more servers of the example software distribution platform 1305 are in communication with a network 1310, which may correspond to any one or more of the Internet and/or any of the example networks 1226 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1232 from the software distribution platform 1305. For example, the software, which may correspond to the example computer readable instructions 1232 of FIG. 12, may be downloaded to the example processor platform 1200, which is to execute the computer readable instructions 1232 to implement the example semantic analyzer 110. In some example, one or more servers of the software distribution platform 1305 periodically offer, transmit, and/or force updates to the software (e.g., the example computer readable instructions 1232 of FIG. 12) to ensure improvements, patches, updates, etc. are distributed and applied to the software at the end user devices.

From the foregoing, it will be appreciated that example methods, apparatus and articles of manufacture have been disclosed that generate code semantics for question-answering. The disclosed methods, apparatus and articles of manufacture improve the efficiency of using a computing device by generating code semantics for input in using self-supervised learning techniques. For example, methods, apparatus and articles of manufacture generate semantic embeddings associated with multiple code blocks to generate a PSG using deep learning techniques. Methods, apparatus and articles of manufacture identify semantic concepts in user queries and output missing semantic concepts based on dependencies in the PSG. The disclosed methods, apparatus and articles of manufacture are accordingly directed to one or more improvement(s) in the functioning of a computer.

Example methods, apparatus, systems, and articles of manufacture to generate code semantics are disclosed herein. Further examples and combinations thereof include the following:

Example 1 includes an apparatus, comprising a concept controller to assign semantic labels to repository data to generate a training set, the semantic labels stored in a first semantic graph, the training set including a first code block associated with a first semantic label and a second code block associated with a second semantic label, a concept determiner to generate a first block embedding based on the first code block and a second block embedding based on the second code block, a graph generator to link the first block embedding to the second block embedding to form a second semantic graph, and a graph parser to output at least one of the first code block or the second code block corresponding to a query based on the second semantic graph.

Example 2 includes the apparatus as defined in example 1, further including a data parser to, in response to determining the repository data includes code, identify an artifact in the code.

Example 3 includes the apparatus as defined in example 2, wherein the artifact includes at least one of a comment, a file name, a function name, a unit test, a specification, a document, or a sequence diagram.

Example 4 includes the apparatus as defined in example 1, further including a data parser to, in response to determining the repository data does not include code, process the repository data using natural language comprehension.

Example 5 includes the apparatus as defined in example 1, wherein the training set includes a third code block, and the concept controller is to assign the first semantic label to the first code block and the third code block, and the second semantic label to the second code block to generate a labeled training set.

Example 6 includes the apparatus as defined in example 5, wherein the concept determiner is to generate a third block embedding based on the third code block, and aggregate the first block embedding and the third block embedding to generate a semantic embedding.

Example 7 includes the apparatus as defined in example 1, wherein the concept determiner is to input the first code block and the second code block into a deep neural network.

Example 8 includes the apparatus as defined in example 7, wherein the deep neural network is to output the first block embedding corresponding to the first code block and the second block embedding corresponding to the second code block.

Example 9 includes the apparatus as defined in example 1, wherein the first block embedding corresponds to a first abstraction layer and the second block embedding corresponds to a second abstraction layer, the first abstraction layer dependent on the second abstraction layer.

Example 10 includes the apparatus as defined in example 9, wherein the first abstraction layer corresponds to computation and the second abstraction layer corresponds to summation.

Example 11 includes the apparatus as defined in example 1, further including a user input analyzer to identify a semantic label in the user input, the semantic label corresponding to the second semantic label.

Example 12 includes the apparatus as defined in example 11, wherein the graph parser is to output the first code block corresponding to the first semantic label.

Example 13 includes a non-transitory computer readable medium comprising instructions that, when executed, cause at least one processor to, at least assign semantic labels to repository data to generate a training set, the semantic labels stored in a first semantic graph, the training set including a first code block associated with a first semantic label and a second code block associated with a second semantic label, generate a first block embedding based on the first code block and a second block embedding based on the second code block, link the first block embedding to the second block embedding to form a second semantic graph, and output at least one of the first code block or the second code block corresponding to a query based on the second semantic graph.

Example 14 includes the non-transitory computer readable medium as defined in example 13, wherein the instructions, when executed, further cause the at least one processor to, in response to determining the repository data includes code, identify an artifact in the code.

Example 15 includes the non-transitory computer readable medium as defined in example 14, wherein the artifact includes at least one of a comment, a file name, a function name, a unit test, a specification, a document, or a sequence diagram.

Example 16 includes the non-transitory computer readable medium as defined in example 13, wherein the instructions, when executed, further cause the at least one processor to, in response to determining the repository data does not include code, process the repository data using natural language comprehension.

Example 17 includes the non-transitory computer readable medium as defined in example 13, wherein the training set includes a third code block, and the instructions, when executed, further cause the at least one processor to assign the first semantic label to the first code block and the third code block, and the second semantic label to the second code block to generate a labeled training set.

Example 18 includes the non-transitory computer readable medium as defined in example 17, wherein the instructions, when executed, further cause the at least one processor to generate a third block embedding based on the third code block, and aggregate the first block embedding and the third block embedding to generate a semantic embedding.

Example 19 includes the non-transitory computer readable medium as defined in example 13, wherein the instructions, when executed, further cause the at least one processor to input the first code block and the second code block into a deep neural network.

Example 20 includes the non-transitory computer readable medium as defined in example 19, wherein the deep neural network is to output the first block embedding corresponding to the first code block and the second block embedding corresponding to the second code block.

Example 21 includes the non-transitory computer readable medium as defined in example 13, wherein the first block embedding corresponds to a first abstraction layer and the second block embedding corresponds to a second abstraction layer, the first abstraction layer dependent on the second abstraction layer.

Example 22 includes the non-transitory computer readable medium as defined in example 21, wherein the first abstraction layer corresponds to computation and the second abstraction layer corresponds to summation.

Example 23 includes the non-transitory computer readable medium as defined in example 13, wherein the instructions, when executed, further cause the at least one processor to identify a semantic label in the user input, the semantic label corresponding to the second semantic label.

Example 24 includes the non-transitory computer readable medium as defined in example 23, wherein the instructions, when executed, further cause the at least one processor to output the first code block corresponding to the first semantic label.

Example 25 includes a method, comprising assigning semantic labels to repository data to generate a training set, the semantic labels stored in a first semantic graph, the training set including a first code block associated with a first semantic label and a second code block associated with a second semantic label, generating a first block embedding based on the first code block and a second block embedding based on the second code block, linking the first block embedding to the second block embedding to form a second semantic graph, and outputting at least one of the first code block or the second code block corresponding to a query based on the second semantic graph.

Example 26 includes the method as defined in example 25, further including, in response to determining the repository data includes code, identifying an artifact in the code.

Example 27 includes the method as defined in example 26, wherein the artifact includes at least one of a comment, a file name, a function name, a unit test, a specification, a document, or a sequence diagram.

Example 28 includes the method as defined in example 25, further including, in response to determining the repository data does not include code, processing the repository data using natural language comprehension.

Example 29 includes the method as defined in example 25, wherein the training set includes a third code block, and further including assigning the first semantic label to the first code block and the third code block, and the second semantic label to the second code block to generate a labeled training set.

Example 30 includes the method as defined in example 29, further including generating a third block embedding based on the third code block, and aggregating the first block embedding and the third block embedding to generate a semantic embedding.

Example 31 includes the method as defined in example 25, further including inputting the first code block and the second code block into a deep neural network.

Example 32 includes the method as defined in example 31, wherein the deep neural network is to output the first block embedding corresponding to the first code block and the second block embedding corresponding to the second code block.

Example 33 includes the method as defined in example 25, wherein the first block embedding corresponds to a first abstraction layer and the second block embedding corresponds to a second abstraction layer, the first abstraction layer dependent on the second abstraction layer.

Example 34 includes the method as defined in example 33, wherein the first abstraction layer corresponds to computation and the second abstraction layer corresponds to summation.

Example 35 includes the method as defined in example 25, further including identifying a semantic label in the user input, the semantic label corresponding to the second semantic label.

Example 36 includes the method as defined in example 35, further including outputting the first code block corresponding to the first semantic label.

Example 37 includes an apparatus, comprising means for controlling concepts to assign semantic labels to repository data to generate a training set, the semantic labels stored in a first semantic graph, the training set including a first code block associated with a first semantic label and a second code block associated with a second semantic label, means for determining concepts to generate a first block embedding based on the first code block and a second block embedding based on the second code block, means for generating graphs to link the first block embedding to the second block embedding to form a second semantic graph, and means for parsing graphs to output at least one of the first code block or the second code block corresponding to a query based on the second semantic graph.

Example 38 includes the apparatus as defined in example 37, further including means for parsing repository data to, in response to determining the data includes code, identify an artifact in the code.

Example 39 includes the apparatus as defined in example 38, wherein the artifact includes at least one of a comment, a file name, a function name, a unit test, a specification, a document, or a sequence diagram.

Example 40 includes the apparatus as defined in example 37, wherein the data parsing means is to, in response to determining the repository data does not include code, process the repository data using natural language comprehension.

Example 41 includes the apparatus as defined in example 37, wherein the training set includes a third code block, and the concept controlling means is to assign the first semantic label to the first code block and the third code block, and the second semantic label to the second code block to generate a labeled training set.

Example 42 includes the apparatus as defined in example 41, wherein the concept determining means is to generate a third block embedding based on the third code block, and aggregate the first block embedding and the third block embedding to generate a semantic embedding.

Example 43 includes the apparatus as defined in example 37, wherein the concept determining means is to input the first code block and the second code block into a deep neural network.

Example 44 includes the apparatus as defined in example 43, wherein the deep neural network is to output the first block embedding corresponding to the first code block and the second block embedding corresponding to the second code block.

Example 45 includes the apparatus as defined in example 37, wherein the first block embedding corresponds to a first abstraction layer and the second block embedding corresponds to a second abstraction layer, the first abstraction layer dependent on the second abstraction layer.

Example 46 includes the apparatus as defined in example 45, wherein the first abstraction layer corresponds to computation and the second abstraction layer corresponds to summation.

Example 47 includes the apparatus as defined in example 37, further including means for analyzing user input to identify a semantic label in the user input, the semantic label corresponding to the second semantic label.

Example 48 includes the apparatus as defined in example 47, wherein the graph parsing means is to output the first code block corresponding to the first semantic label.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus, comprising:
a concept controller to assign semantic labels to repository data to generate a training set, the semantic labels stored in a first semantic graph, the training set including a first code block associated with a first semantic label and a second code block associated with a second semantic label;
a concept determiner to generate a first block embedding based on the first code block and a second block embedding based on the second code block;
a graph generator to link the first block embedding to the second block embedding to form a second semantic graph; and
a graph parser to output at least one of the first code block or the second code block corresponding to a query based on the second semantic graph.

2.-4. (canceled)

5. The apparatus as defined in claim 1, wherein the training set includes a third code block, and the concept controller is to assign the first semantic label to the first code block and the third code block, and the second semantic label to the second code block to generate a labeled training set.

6. The apparatus as defined in claim 5, wherein the concept determiner is to:
generate a third block embedding based on the third code block; and
aggregate the first block embedding and the third block embedding to generate a semantic embedding.

7. The apparatus as defined in claim 1, wherein the concept determiner is to input the first code block and the second code block into a deep neural network.

8. The apparatus as defined in claim 7, wherein the deep neural network is to output the first block embedding corresponding to the first code block and the second block embedding corresponding to the second code block.

9. The apparatus as defined in claim 1, wherein the first block embedding corresponds to a first abstraction layer and the second block embedding corresponds to a second abstraction layer, the first abstraction layer dependent on the second abstraction layer.

10. (canceled)

11. The apparatus as defined in claim 1, further including a user input analyzer to identify a semantic label in the user input, the semantic label corresponding to the second semantic label.

12. The apparatus as defined in claim 11, wherein the graph parser is to output the first code block corresponding to the first semantic label.

13. A non-transitory computer readable medium comprising instructions that, when executed, cause at least one processor to, at least:
assign semantic labels to repository data to generate a training set, the semantic labels stored in a first semantic graph, the training set including a first code block associated with a first semantic label and a second code block associated with a second semantic label;
generate a first block embedding based on the first code block and a second block embedding based on the second code block;
link the first block embedding to the second block embedding to form a second semantic graph; and
output at least one of the first code block or the second code block corresponding to a query based on the second semantic graph.

14.-16. (canceled)

17. The non-transitory computer readable medium as defined in claim 13, wherein the training set includes a third code block, and the instructions, when executed, further cause the at least one processor to assign the first semantic label to the first code block and the third code block, and the second semantic label to the second code block to generate a labeled training set.

18. The non-transitory computer readable medium as defined in claim 17, wherein the instructions, when executed, further cause the at least one processor to:
generate a third block embedding based on the third code block; and
aggregate the first block embedding and the third block embedding to generate a semantic embedding.

19.-20. (canceled)

21. The non-transitory computer readable medium as defined in claim 13, wherein the first block embedding corresponds to a first abstraction layer and the second block embedding corresponds to a second abstraction layer, the first abstraction layer dependent on the second abstraction layer.

22. (canceled)

23. The non-transitory computer readable medium as defined in claim 13, wherein the instructions, when executed, further cause the at least one processor to identify a semantic label in the user input, the semantic label corresponding to the second semantic label.

24. The non-transitory computer readable medium as defined in claim 23, wherein the instructions, when executed, further cause the at least one processor to output the first code block corresponding to the first semantic label.

25. A method, comprising:
assigning semantic labels to repository data to generate a training set, the semantic labels stored in a first semantic graph, the training set including a first code block associated with a first semantic label and a second code block associated with a second semantic label;
generating a first block embedding based on the first code block and a second block embedding based on the second code block;
linking the first block embedding to the second block embedding to form a second semantic graph; and
outputting at least one of the first code block or the second code block corresponding to a query based on the second semantic graph.

26.-28. (canceled)

29. The method as defined in claim 25, wherein the training set includes a third code block, and further including assigning the first semantic label to the first code block and the third code block, and the second semantic label to the second code block to generate a labeled training set.

30. The method as defined in claim 29, further including:
generating a third block embedding based on the third code block; and
aggregating the first block embedding and the third block embedding to generate a semantic embedding.

31.-32. (canceled)

33. The method as defined in claim 25, wherein the first block embedding corresponds to a first abstraction layer and the second block embedding corresponds to a second abstraction layer, the first abstraction layer dependent on the second abstraction layer.

34. (canceled)

35. The method as defined in claim 25, further including identifying a semantic label in the user input, the semantic label corresponding to the second semantic label.

36. The method as defined in claim 35, further including outputting the first code block corresponding to the first semantic label.

37.-48. (canceled)
